(19) United States
(12) Patent Application Publication
(10) Pub. No.: US 2025/0017155 A1
(43) Pub. Date: Jan. 16, 2025

(54) DRIP LINE TO DRIP SCREW COUPLER

(71) Applicant: KJ Ketterling Enterprises, LLC, Twin Falls, ID (US)

(72) Inventor: Kody J. KETTERLING, Twin Falls, ID (US)

(73) Assignee: KJ Ketterling Enterprises, LLC, Twin Falls, ID (US)

(21) Appl. No.: 18/221,379

(22) Filed: Jul. 12, 2023

(51) Int. Cl. A01G 25/02

(52) U.S. Cl. CPC A01G 25/023; A01G 25/026

(57) ABSTRACT

A drip screw coupler attaches a drip irrigation line to a rigid emitter. The drip screw coupler defines a flow channel between a top end and an outlet end that has an outer diameter sealably friction fittable entirely within an inlet port of the rigid emitter. A connecting arm extends from the top end for sealable attachment to the drip irrigation line. The outer surface of the coupler is configured for grasping between adjacent fingers of a user to facilitate manual connections and disconnections. The coupler may be injection molded as a singular component.

### BACKGROUND OF THE INVENTION

### Field of the Invention

The present application relates generally to irrigation systems, and more specifically to a coupler for connecting an irrigation drip line to a drip line emitter.

### Description of Related Art

Drip irrigation systems are well known in the art as an alternative to conventional pop-up or rotary style sprinkling systems. Drip irrigation provides better precision and efficiency for water distribution in environments such as gardens and partially planted landscapes by targeting the water supply directly to the vegetation being watered. Drip irrigation releases water under a relatively low pressure and flow rate through drip emitters located on the ground in close proximity to the targeted vegetation. Drip emitters are typically connected to an irrigation line under control of solenoid valves by flexible hoses that can be easily routed around a garden above ground.

Known drip emitters have several different forms. For example, some drip emitters are rigid perforated terminals connected to the flexible feeder line, for example, by barbed hose connections, while others are simply regularly spaced holes formed directly in feeder line, which is also known as trickle hose.

Other emitter types can be designed as rigid screws or stakes that can be driven deep into the soil using tools such as hammers and drills. These emitters deliver water deeper into the soil, encouraging plant roots to grow down into the soil, promoting stronger and healthier growth.

A problem exists with the current manner in which rigid emitters such as drip screws are connected to a feeder line. Connectors for this type of emitter do not always provide a secure connection needed to properly direct a steady flow of water. The problem arises when the feeder line is inserted directly into an aperture at the top end of the rigid emitter and held in place by friction. As a result, drip lines may be easily uncoupled simply due to water pressure flowing through the line or from user manipulation of the line during routine maintenance or landscaping in the area around the emitter. Further, drip line emitters connected in this fashion are more likely to leak due to the unsecure connection.

Thus, what is needed is an improved coupler for irrigation systems, in particular for coupling drip irrigation lines to rigid emitters such as drip screws.

### SUMMARY OF THE INVENTION

The present invention improves drip irrigation systems by providing a specialized drip screw coupler designed for installation between a drip irrigation feeder line and a rigid emitter, such as a drip screw. The drip screw coupler provides a user with an easy means to reliably connect a drip irrigation line with various rigid emitters by manual action.

In one embodiment, a drip screw coupler includes the following elements: (1) a channel having a top end and an outlet end and a means for connecting to an inlet end of a drip screw emitter; and (2) at least one connecting arm having a means for attaching to a drip irrigation feeder line. In some embodiments, the means for connecting the channel to the drip screw emitter is the frictional engagement between the outer diameter of the channel proximate the outlet end and an aperture defining the inlet end of the drip screw emitter. In one exemplary embodiment, the channel has an outer diameter of about 0.3 inches and a longitudinal length of about 1.0 inches. In some embodiments, the channel has a smooth outer surface and may be cylindrical in shape, which may facilitate connecting to the drip screw emitter.

In another embodiment of the invention, the outlet end of the channel can be beveled or chamfered. In some embodiments, the beveled end may form an angle of about 45 degrees. In other embodiments, the top end of the channel may also be beveled or chamfered. The beveled top end may form an angle of about 45 degrees.

In some embodiments of the invention, the connecting arm can extend from the top end at an angle of about 90 degrees. In one implementation, the outer diameter of the connecting arm may be nonuniform and configured to form a barbed coupling. The barbed coupling may have a maximum outer diameter of about 0.16 inches.

In another embodiment of the drip screw coupler, there is an internal flow path defined at the inlet end of the connecting arm and in fluid communication with the outlet end of the channel. In some embodiments the flow path may comprise of a first direction traveling through the connecting arm and a second direction traveling through the channel. The diameter of the internal flow path may be uniform from the inlet end to the outlet end. Alternatively, the flow path may have a non-uniform diameter from the inlet end to the outlet end. For example, there may be a first diameter defined through the connecting arm, which may be about 0.09 inches, and a second diameter defined through the channel, which may be larger than the first diameter through the connecting arm. In some embodiments, a transition from the first diameter to the second diameter occurs internally at the top end of the channel.

In more elaborate embodiments, a drip screw coupler according to the invention may have two or more connecting arms extending from the top end of the channel. In such embodiments, each of the two or more connecting arms preferably form a right angle about the top end of the channel. In preferred embodiments, there are two connecting arms that lie in the same plane with one another and each form a right angle about the top end of the channel.

In the embodiments having two or more connecting arms, a common internal flow path may fluidically connect a first connecting arm, a second connecting arm and the outlet end of the channel. In such embodiments, a plurality of drip emitters can be connected in series along a common drip irrigation line and utilize a single water source for delivering water to each of the plurality of drip emitters.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. Dimensions shown are exemplary only. In the drawings, like reference numerals may designate like parts throughout the different views, wherein:

FIG. 1 is an isometric view of one embodiment of a drip screw coupler according to the present invention.

FIG. 2 is a partially transparent side view of the drip screw coupler of FIG. 1.

FIG. 3 is a partially transparent bottom view of the drip screw coupler of FIG. 1.

FIG. 4 is an isometric view of one embodiment of a double arm drip screw coupler according to the present invention.

FIG. 5 is a partially transparent side view of the double arm drip screw coupler of FIG. 4.

FIG. 6 is a partially transparent bottom view of the double arm drip screw coupler of FIG. 5.

FIG. 7 is a side view of an embodiment of a rigid drip screw emitter with which a drip screw coupler according to the present invention may be used.

FIG. 8 is a top view of the rigid drip screw emitter of FIG. 7.

### DETAILED DESCRIPTION OF THE INVENTION

The following disclosure presents exemplary embodiments of a drip screw coupler for connecting a drip line to a rigid emitter according to the present invention. The invention consists primarily of a channel that has a means for attachment to a drip screw and one or more connecting arms extending from the channel and having a means for connecting to a drip irrigation line. An internal flow path is defined through the connecting arm and the channel so that an inlet end of the connecting arm is in fluid communication with the outlet end of the channel. The diameter of the internal flow path may be uniform or nonuniform, depending on the embodiment.

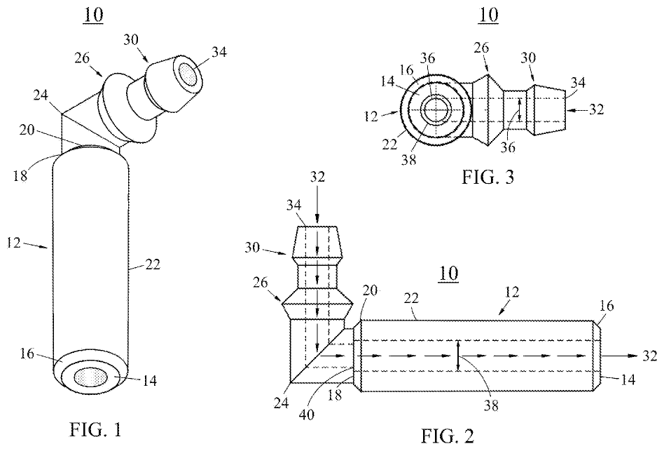

FIG. 1 is an isometric view of one embodiment of a drip screw coupler 10 for connecting a drip line to a rigid emitter according to the present invention. Generally, the drip screw coupler 10 may be formed with a channel 12 having an outlet end 14 and a top end 18. The outlet end 14 may include a chamfered or beveled edge 16. Similarly, the top end 18 may be formed with a chamfered or beveled top 20. The channel 12 may be formed as any shape, e.g., cylindrical, rectangular, hexagonal, or any other shape. In preferred embodiments, the channel 12 has a cylindrical shape. Throughout this disclosure, for illustrative purposes the rigid emitter to which the drip screw coupler 10 is designed to engage may be alternatively referred to as a drip screw emitter; however, the inventive embodiments disclosed herein are suitable for coupling to many other types and shapes of rigid emitters.

The channel 12 includes a means for connecting the outlet end 14 to an inlet of a drip screw emitter. In some preferred embodiments, the channel 12 is generally cylindrical and includes a chamfered or beveled edge 16 circumvolving the outlet end 14. The channel 12 defines an outer diameter 22. Preferably, the outer diameter 22 is substantially equal to the inner diameter of an aperture that is defined in the drip screw emitter and configured to receive a flow of water. The connection means may be the frictional engagement between the outer diameter 22 of the generally cylindrical channel 12 and the corresponding cylindrical aperture forming the inlet of the drip screw emitter. In preferred embodiments, the channel 12 sealably connects to the inlet of a rigid emitter, meaning the connection is such that there are no leaks and is fully engaged to form a seal. The beveled edge 16 at the outlet end 14 may aid a user installing the drip screw coupler 10 into a drip screw by guiding the channel 12 into concentric alignment with the aperture of the drip screw. In preferred embodiments, the outlet end 14 fits entirely within the aperture of the rigid emitter and a portion of the outer diameter 22 adjacent to the outlet end 14 passes entirely into the emitter to be in full frictional contact with the inner diameter of the rigid emitter. In embodiments where the channel 12 has a cylindrical shape, the frictionally engageable portion of the outer diameter 22 extends from the outlet end 14 to an intermediate height along the channel 12. In one embodiment, the frictionally engageable segment is between about ⅛ and about 1.0 inch in length. However, in alternative embodiments and depending on the size of the drip screw emitter, the full length of the outer diameter 22 of the channel 12 may be frictionally engaged within the inlet of the emitter. Alternatively, the connection means may be a threaded or snap-fit engagement between the channel 12 and an inlet of the drip screw emitter.

At least one connecting arm 26 extends from the channel 12. In preferred embodiments, the connecting arm 26 is formed as an integral extension of the top end 18 and may define a right angle 24. Alternate embodiments may include two or more connecting arms 26, which may extend from the top end 18 at angles other than 90 degrees. Each connecting arm 26 may be cylindrical, rectangular, hexagonal, or any other shape. The right angle connection 24 allows a user to more easily grasp the coupler 10 near the top end 18 and manipulate engagement of the channel 12 to an emitter. In addition, the outer diameter 22 of the channel 12 and the connecting arm 26 are preferably sized for grasping between a user's adjacent fingers, such as the index and middle fingers, or the thumb and index finger.

Each connecting arm 26 includes a means for connecting to a drip irrigation line. The connection means may be a frictional engagement between the connecting arm 26 and a drip irrigation line. Alternatively, the connecting means may be threaded or snap-fit engagement between the connecting arm 26 and a drip irrigation line. In some preferred embodiments, the connecting arm 26 has a barbed end 30 configured to sealably connect to a drip irrigation line. The barbed end 30 may aid a user installing the drip screw coupler 10 into a drip irrigation line by guiding the drip screw coupler into concentric alignment with the open end of the drip irrigation line and allowing the user to securely fasten the drip screw coupler to the drip irrigation line by conventional means. Connecting arm 26 may be further configured with a recessed portion behind the barbed end 30 to accommodate a hose clamp, or other fastening devices, after engagement to the drip irrigation line.

In one embodiment, the drip screw coupler 10 may comprise a singular component in which the channel 12 and the connecting arm 26 are integrally formed from the same material during a single process. In another embodiment, the channel 12 and the connecting arm 26 may be formed as distinct components and assembled together. For example, the top end 18 may be configured with threading that allows the channel 12 to be threaded onto, or unscrewed from, complimentary threading provided on the connecting arm 26. Alternatively, the channel 12 and the connecting arm 26 may be configured for a snap-fit assembly using a combination of notches and grooves on each respective component piece.

The drip screw coupler 10, or any part thereof, may be formed at least partially from metal, such as copper, brass, or steel, by machining, casting, welding, or other known manufacturing techniques. Alternately, the drip screw coupler 10, or any part thereof, may be formed from plastic by injection molding or 3-D printing according to known techniques using one or more polymer materials.

FIG. 2 is a partially transparent side view of the drip screw coupler 10. The drip screw coupler 10 has an internal flow path 32 which fluidically connects an inlet opening 34 of the connecting arm 26 to the outlet end 14 of the channel 12. In some embodiments, the flow path 32 has a nonuniform internal diameter. For example, a first internal diameter 36 may be defined through the connecting arm 26 and extend to a junction 40 defined at the top end 18 of the channel 12. A second internal diameter 38 may be defined through the channel 12 and extend from the junction 40 to the outlet end 14. The junction 40 fluidically connects the first diameter 36 to the second diameter 38 to ensure the inlet opening 34 is maintained in fluid communication with the outlet end 14.

FIG. 3 is a partially transparent bottom view of the drip screw coupler 10. In some embodiments, the flow path 32 has a non-uniform internal diameter. In some embodiments, the first internal diameter 36 extending through the connecting arm 26 is less than the second internal diameter 38 extending through the channel 12.

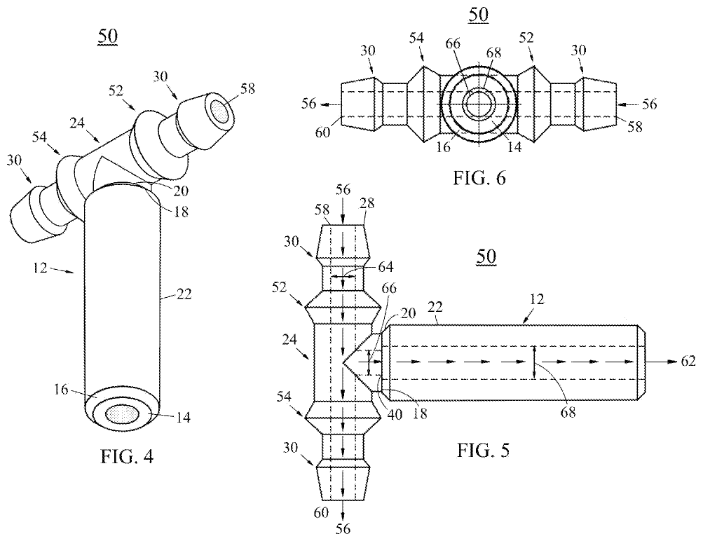

FIG. 4 is an isometric view of an alternative embodiment of a double arm drip screw coupler 50 for connecting a drip line to a drip screw according to the present invention. The double arm drip screw coupler 50 preferably has two connecting arms 52, 54 connected to the top end 18 of the channel 12. In preferred embodiments, each of the two connecting arms 52, 54 is connected to the channel 12 by a right angle connection 24 such that opening 58 opposes opening 60. Preferably, a central axis (at 56) runs through both connecting arms 52, 54 and is substantially perpendicular to the longitudinal axis of the channel 12.

FIG. 5 is a partially transparent side view of the double arm drip screw coupler 50. A common flow path 56 fluidically connects the outlet end 14 with an inlet opening 58 of the first connecting arm 52 and the outlet opening 60 of the second connecting arm 54. Note, reference to the inlet opening 58 and outlet opening 60 is made for descriptive purposes only and may change depending on the orientation in which the double arm drip screw coupler 50 is installed and the direction of the water source. In some embodiments, the common flow path 56 splits at the right angle connection 24 creating a second direction 62 of flow. In preferred embodiments, the common flow path 56 has a uniform internal diameter 64 through the connecting arms 52, 54 such that the inlet opening 58 is in fluid communication with the outlet opening 60. The second direction 62 may have a first internal diameter 66 and a second internal diameter 68. The first internal diameter may be equal to the uniform internal diameter 64 extending through the two connecting arms 52, 54. A junction 40 transitions the first internal diameter 66 to the second internal diameter 68, preferably causing an increase to the internal diameter so that the second internal diameter is larger than the first. The second internal diameter 68 extends from the junction 40 to the outlet end 14 of the channel 12. In preferred embodiments, the second internal diameter 68 is greater than the first internal diameter 66, to cause a decrease in flow velocity across the junction 40 and thereby facilitate dripping of water from ports of a connected emitter, rather than delivering the water as stream or jet.

FIG. 6 is a partially transparent bottom view of the double arm drip screw coupler 50. In some embodiments, the second direction 62 of the flow path may have a first internal diameter 66 and a second internal diameter 68. In preferred embodiments, the second internal diameter 68 is larger than the first internal diameter 66 to cause a decrease in the pressure of water delivered to the engaged emitter.

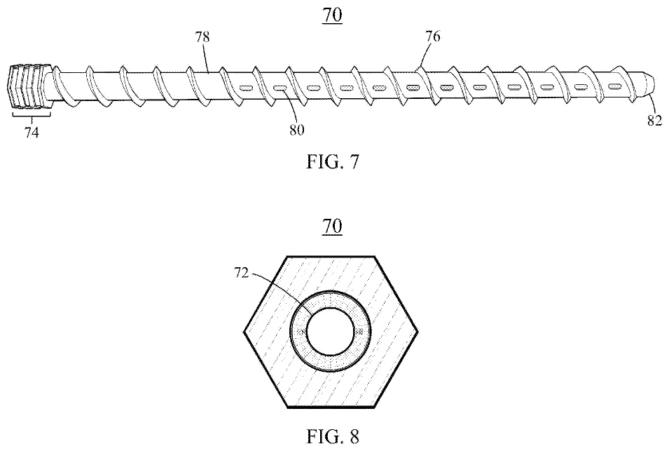

FIGS. 7 and 8 are side and top views, respectively, of one example of a rigid drip screw emitter 70 that may be connected to a water source using any of the exemplary embodiments of the drip screw coupler disclosed herein. The rigid drip screw emitter 70 has an inlet port 72, located in the center of the head 74. In preferred embodiments, the head 74 is hexagonal to allow users to more easily install the rigid drip screw emitter 70 by use of a drill or other conventional means, and to allow users to more easily grasp the head. In preferred embodiments, there is spiraled threading 76 along the shaft 78 to aid users in effectively screwing the rigid drip screw emitter 70 into the ground. In some preferred embodiments, there are drip apertures 80 defined along the sides of the shaft 78 to allow the water delivered to emitter to escape into the surrounding environment. In preferred embodiments, the rigid drip screw emitter 70 has a beveled end 82 to further aid users in installation. In preferred embodiments, the rigid drip screw emitter 70 is hollow throughout a central axis, from the inlet port 72 to the beveled end 82 to provide a flow path.

The inlet port 72 receives the outlet end 14 of the channel 12. The length of the head 74 defines the portion of the outer diameter 22 of the channel 12 that will be inserted therein. This portion of the outer diameter 22 of the channel 12 frictionally engages the inner surface of the head 74 to secure the drip screw coupler therein. Typically, the rigid drip screw emitter 70 is installed before manually connecting with the drip screw coupler 10 or 50. Depending on the use of the rigid drip screw emitter 70, only the head 74 may be exposed above ground. The drip screw coupler 10 and the double arm drip screw coupler 50 each may aid users with manual attachment and detachment to the rigid drip screw emitter 70, as each coupler is preferably sized for grasping between a users' adjacent fingers.

In use, the drip screw coupler 10 and the double arm drip screw coupler 50 can be deployed together to create a complete irrigation line. The drip screw coupler 10 is particularly useful at an end point of the irrigation line where there are no further rigid emitters in the line. In contrast, the double arm drip screw coupler 50 is useful at intermediate locations of the irrigation line where it is desired to connect multiple rigid emitters in series.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A coupler for a drip irrigation system, comprising:
an enclosed flow channel having a top end, an outlet end, and a means for sealably connecting the outlet end entirely within an inlet port of a rigid emitter; and
at least one connecting arm extending from the top end and having an inlet end and a means for sealably attaching the inlet end to a drip irrigation feeder line to form a flow path from the inlet end to the outlet end.

2. The coupler of claim 1, wherein the sealably connecting means comprises the outlet end having an outer diameter friction fittable within the inlet port of the rigid emitter.

3. The coupler of claim 1, wherein the outlet end is beveled.

4. The coupler of claim 1, wherein the enclosed flow channel comprises an outer surface configured for grasping between adjacent fingers of a user.

5. The coupler of claim 1, wherein the enclosed flow channel is cylindrical.

6. The coupler of claim 1, wherein the at least one connecting arm extends from the top end at an angle of substantially 90 degrees with respect to a longitudinal axis defined through the enclosed flow channel.

7. The coupler of claim 1, wherein the inlet end of the at least one connecting arm comprises a barbed end.

8. The coupler of claim 7, wherein the sealably attaching means comprises the barbed end configured to frictionally engage the drip irrigation feeder line.

9. The coupler of claim 1, wherein the top end is beveled.

10. The coupler of claim 1, wherein the inlet end is fluidically connected to the outlet end by an internal flow path that has a nonuniform diameter.

11. A coupler for a drip irrigation system, comprising:
a channel having a top end, an outlet end extending from the top end, and a means for sealably connecting the outlet end entirely within an inlet end of a rigid emitter; and
at least two connecting arms, each extending from the top end and each having an end opening and a means for sealably attaching the end opening to a drip irrigation feeder line.

12. The coupler of claim 11, wherein the sealably connecting means comprises the channel having an outer diameter at the outlet end friction fittable to the inlet end of the rigid emitter.

13. The coupler of claim 11, wherein the at least two connecting arms each extend from the top end at an angle of substantially 90 degrees with respect to a longitudinal axis defined through the channel.

14. The coupler of claim 13, wherein each of the at least two connecting arms lies in a common plane that is substantially perpendicular to the longitudinal axis of the channel.

15. The coupler of claim 11, wherein the end opening of each of the at least two connecting arms comprises a barbed coupling.

16. The coupler of claim 15, where each of the sealably attaching means comprises the barbed coupling configured to frictionally engage the drip irrigation feeder line.

17. The coupler of claim 11, wherein each end opening of the connecting arms are in fluid communication with the outlet end of the channel via a common internal flow path.

18. The coupler of claim 17, wherein the common internal flow path has a non-uniform diameter.

19. The coupler of claim 17, wherein the common internal flow path defines first and second flow directions, wherein the first flow direction runs from an end opening of a first connecting arm to an end opening of a second connecting arm, and wherein the second flow direction runs from the top end to the outlet end.

20. A coupler for a drip irrigation system, comprising:
a channel having a top end having beveling of about 45 degrees, an outlet end having beveling of about 45 degrees, a cylindrical body having a smooth outer surface integrally connecting the top end to the outlet end, and an inner channel flow path fluidically connecting the top end to the outlet end, wherein the channel is about 1.0 inch in longitudinal length and the cylindrical body has an outer diameter of between about 0.28 and about 0.32 inches, wherein the outlet end is configured to entirely frictionally engage within an inlet port of a rigid emitter; and
at least two barbed connecting arms lying in a common plane substantially perpendicular to the longitudinal length of the channel, wherein each barbed connecting arm has an outer diameter of between about 0.14 and about 0.18 inches, a fluid aperture opening into an inner arm flow path defining an inner diameter of between about 0.07 and about 0.11 inches, wherein each fluid aperture fluidically connects each inner arm flow path to the inner channel flow path.
